(19) United States
(12) Patent Application Publication
(10) Pub. No.: US 2013/0024825 A1
(43) Pub. Date: Jan. 24, 2013

(54) MASK DATA GENERATION METHOD, MASK GENERATION METHOD, AND RECORDING MEDIUM

(71) Applicants: Osamu YAMANE, Kanagawa (JP); Kazuyuki Masukawa, Kanagawa (JP)

(72) Inventors: Osamu YAMANE, Kanagawa (JP); Kazuyuki Masukawa, Kanagawa (JP)

(73) Assignee: Kabushiki Kaisha Toshiba, Tokyo (JP)

(21) Appl. No.: 13/413,153

(22) Filed: Mar. 6, 2012

(30) Foreign Application Priority Data
Jul. 19, 2011 (JP) 2011-158275

(51) Int. Cl. G06F 17/50

(52) U.S. Cl. 716/55

(57) ABSTRACT

According to one embodiment, there is provided a mask data generation method. The method repeatedly arranges hole patterns with a pitch Px in an x direction and a pitch Py in a y direction in each of a first block region and a second block region aligned in the y direction. The method specifies a pitch P between the hole pattern in the first block region closest to the second block region and the hole pattern in the second block region closest to the first block region. The method determines a position in which a subsidiary pattern is to be arranged in an inter-block region between the first block region and the second block region according to a relative size of the pitch P to the pitch Py and arranges the subsidiary pattern in the determined position.

### CROSS-REFERENCE TO RELATED APPLICATIONS

This application is based upon and claims the benefit of priority from Japanese Patent Application No. 2011-158275, filed on Jul. 19, 2011; the entire contents of which are incorporated herein by reference.

### FIELD

Embodiments described herein relate generally to a mask data generation method, a mask generation method, and a recording medium.

### BACKGROUND

In recent years, with the miniaturization of patterns constituting a semiconductor device, tolerance of variations in dimensions of the patterns has become smaller and it has become difficult to satisfy required specifications by merely individually tuning each process condition. Thereby, it is necessary to improve the exposure margin including exposure latitude and a depth of focus.

### BRIEF DESCRIPTION OF THE DRAWINGS

FIG. 1 is a diagram illustrating a configuration of a computer for executing a mask data generation program according to an embodiment;

FIG. 2 is a flowchart illustrating a mask data generation method according to an embodiment;

FIG. 3A is a view illustrating an illumination shape in an embodiment;

FIG. 3B is a view illustrating a mask data generation method according to an embodiment;

FIG. 3C is a view illustrating a mask data generation method according to an embodiment;

FIG. 4 is a diagram illustrating a configuration of an exposure device that performs an exposure process using a mask generated by a mask generation method according to an embodiment;

FIG. 5 is a diagram illustrating effects of an embodiment;

FIG. 6 is a diagram illustrating effects of an embodiment; and

FIG. 7 is a diagram illustrating a structure example of a semiconductor device fabricated using a mask generated by a mask generation method according to an embodiment.

### DETAILED DESCRIPTION

In general, according to one embodiment, there is provided a mask data generation method. The method repeatedly arranges hole patterns with a pitch Px in an x direction and a pitch Py in a y direction in each of a first block region and a second block region aligned in the y direction. The method specifies a pitch P between the hole pattern in the first block region closest to the second block region and the hole pattern in the second block region closest to the first block region. The method determines a position in which a subsidiary pattern is to be arranged in an inter-block region between the first block region and the second block region according to a relative size of the pitch P to the pitch Py and arranges the subsidiary pattern in the determined position.

Exemplary embodiments of a mask data generation method, a mask generation method, and a recording medium will be explained below in detail with reference to the accompanying drawings. The present invention is not limited to the following embodiments.

### Embodiment

A mask data generation method, a mask generation method, and a recording medium according to an embodiment are used, for example, in a lithography process of a semiconductor device fabrication process. For example, when mask data for hole patterns to be formed in a given layer is generated, a mask data generation program read from a recording medium is executed and the mask data is generated. A mask is generated using the generated mask data.

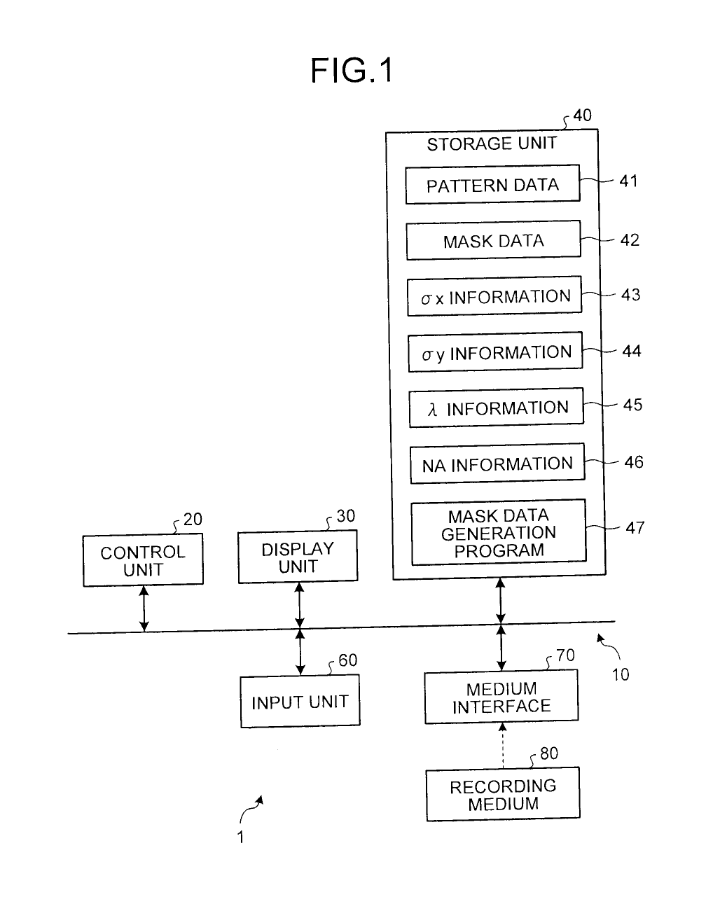

Next, a configuration of a computer for executing the mask data generation program according to an embodiment will be described with reference to FIG. 1.

A computer 1 includes a bus line 10, a control unit 20, a display unit 30, a storage unit 40, an input unit 60, and a medium interface 70.

The control unit 20, the display unit 30, the storage unit 40, the input unit 60 and the medium interface 70 are connected with one another via the bus line 10. The medium interface 70 is configured so that a recording medium 80 can be connected to the medium interface 70.

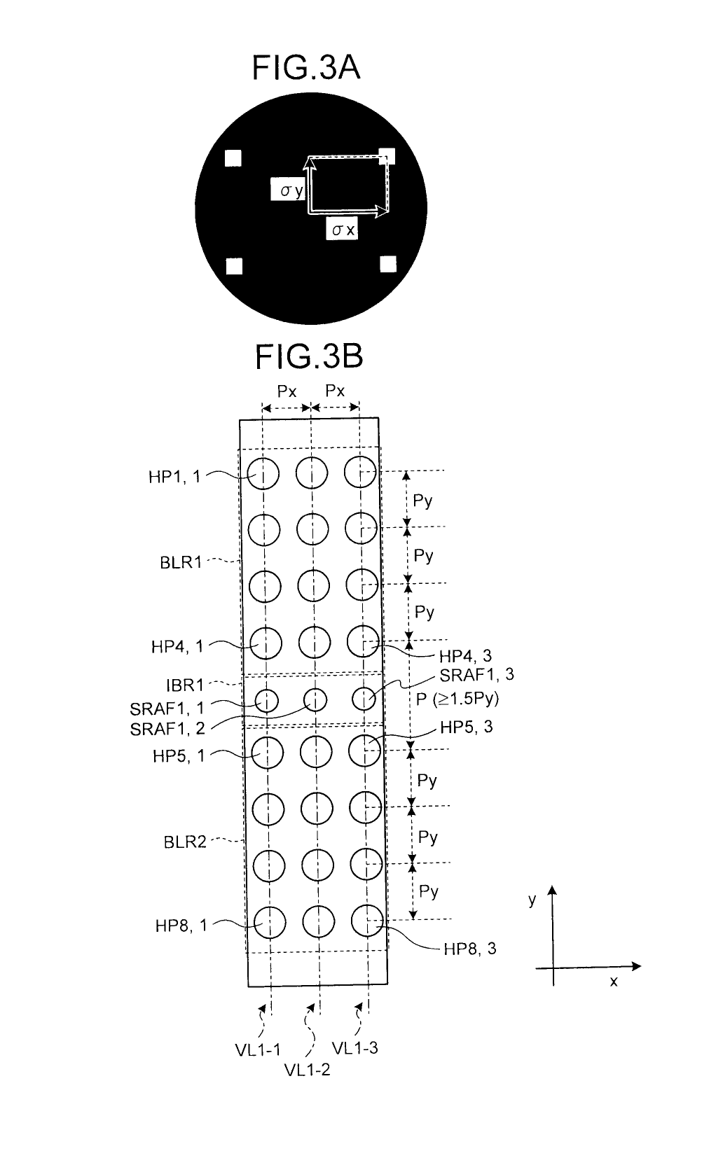

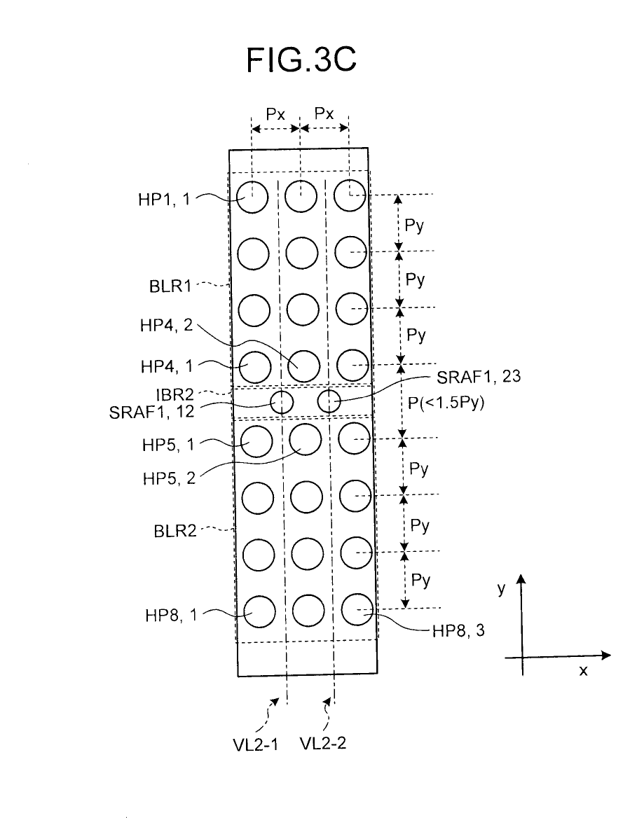

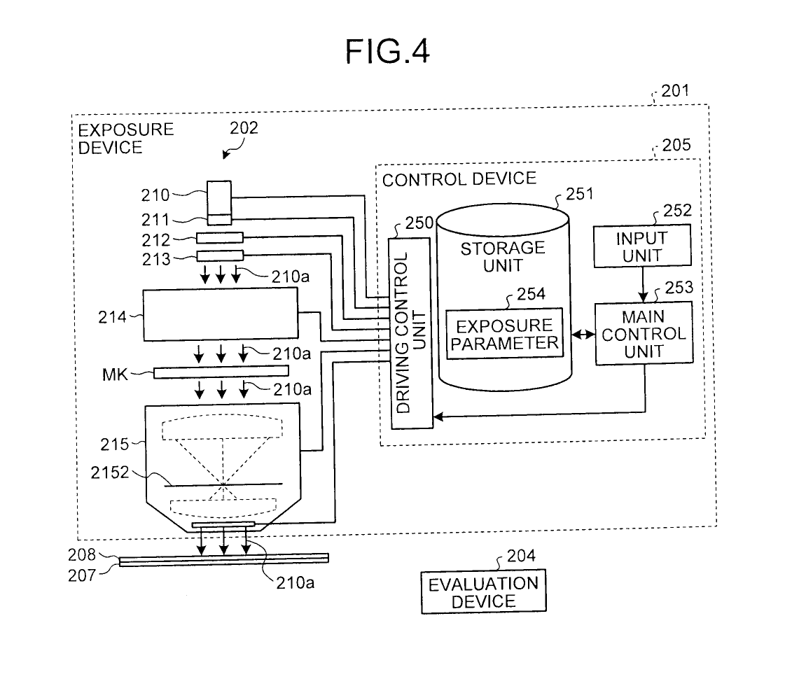

Pattern data 41, mask data 42, σx information 43, σy information 44, λ information 45, NA information 46, and a mask data generation program 47 are stored in the storage unit 40. The pattern data 41 is data of a layout-designed pattern (hereinafter referred to as layout pattern) in designing, for example, an integrated circuit. The mask data 42 is data for causing a pattern such as Cr to be drawn in a mask MK (see FIG. 4). The σx information 43 is information on σx (see FIG. 3A) indicating a distance in an x direction of each bright point of a quadrupole illumination from an optical axis. The σy information 44 is information on σy (see FIG. 3A) indicating a distance in a y direction of each bright point of the quadrupole illumination from the optical axis. The λ information 45 is information on a wavelength λ of an exposure light of an exposure device 201 (see FIG. 4). The NA information 46 is information on a numerical aperture NA at a side of an image of a projection optical system 215 of the exposure device 201. The mask data generation program 47 is a program for generating the mask data 42. Further, the mask MK is irradiated with the illumination light of the quadrupole illumination by an illumination optical system 214 of the exposure device 201 (see FIG. 4) and is used to form a latent image in a photosensitive material on a substrate via the projection optical system 215.

The control unit 20 is, for example, a CPU, a GPU, a DSP or a microcomputer, and further includes a cache memory for temporary storage. The display unit 30 is a display device such as a CRT display or a liquid crystal display. The storage unit 40 is, for example, a memory or a hard disk. The input unit 60 is, for example, a keyboard or a mouse. The medium interface 70 is, for example, a flexible disk drive, a CD-ROM drive or a USB interface. The recording medium 80 is a flexible disk, a CD-ROM, a USB memory or the like.

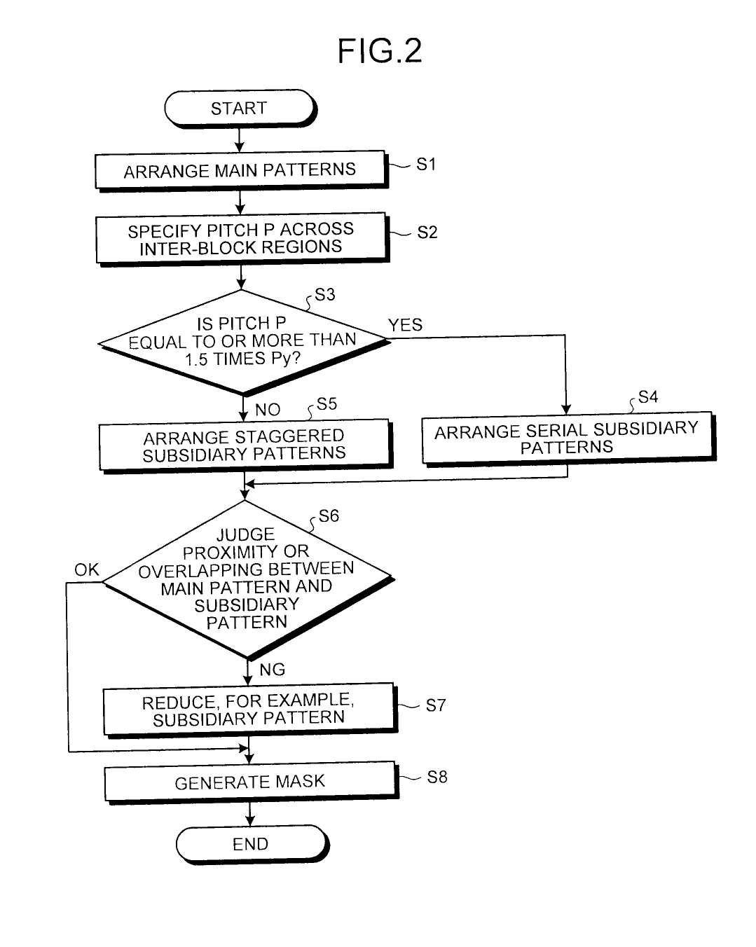

Next, the mask data generation method according to the embodiment will be described with reference to FIGS. 2 and 3A to 3C. FIG. 2 is a flowchart illustrating a flow of the mask data generation method. FIG. 3A is a view illustrating a shape of an illumination light used in the present embodiment. FIGS. 3B and 3C are views illustrating a method of arranging main patterns and subsidiary patterns in the mask data generation method. The main pattern has a dimension equal to or more than a resolution limit of the exposure device 201, and the subsidiary pattern has a dimension less than the resolution limit of the exposure device 201.

In step S1, the control unit 20 of the computer 1 arranges the main patterns (e.g., hole patterns).

Specifically, the σx information 43, the σy information 44, the λ information 45, and the NA information 46 are input to the input unit 60 by a user in advance and stored in the storage unit 40 via the control unit 20.

Further, the recording medium 80 having the mask data generation program 47 recorded thereon is connected to the medium interface 70. The mask data generation program 47 is installed, and stored in the storage unit 40 via the control unit 20.

An instruction to start up the mask data generation program 47 is input to the input unit 60 by the user. The control unit 20 receives the instruction to start up the mask data generation program 47, and starts up the mask data generation program 47 by referencing the storage unit 40 based on the start-up instruction. The control unit 20 displays the pattern data 41 on the display unit 30 by referencing the storage unit 40 according to the mask data generation program 47.

An instruction to arrange the main patterns is input to the input unit 60 by the user having viewed the pattern data 41. For example, a designation instruction to designate arrangement positions of first and second block regions BLR1 and BLR2, for example as illustrated in FIGS. 3B and 3C, is input to the input unit 60 as the instruction to arrange the main pattern. The control unit 20 determines the arrangement positions of the first and second block regions BLR1 and BLR2 according to the instruction to designate the first and second block regions BLR1 and BLR2. In this case, as the arrangement positions of the first and second block regions BLR1 and BLR2 are determined, positions of inter-block regions IBR1 and IBR2 are also determined, for example as illustrated in FIGS. 3B and 3C. The inter-block regions IBR1 and IBR2 are regions between the first and second block regions BLR1 and BLR2. The first and second block regions BLR1 and BLR2 aligned in the y direction will be illustrated hereinafter, but the same applies to a first block region and a second block region aligned in the x direction by replacing x with y.

Further, the control unit 20 acquires the σx information 43, the σy information 44, the λ information 45, and the NA information 46 by referencing the storage unit 40 based on the instruction to designate the first and second block regions BLR1 and BLR2. The control unit 20 repeatedly arranges the hole patterns with a pitch:

Px=λ/(2×NA×σ×) Equation 1

in the x direction and a pitch:

Py=λ/(2×NA×σy) Equation 2

in the y direction in the first block region BLR1 and the second block region BLR2 based on the σx information 43, the σy information 44, the λ information 45, and the NA information 46. The control unit 20, for example, overwrites and stores the pattern data 41 containing information on the plurality of hole patterns as new pattern data 41 in the storage unit 40, and generates the information on the plurality of hole patterns as mask data 42 and stores the mask data 42 in the storage unit 40.

In Equation 1, σx is specified by the σx information 43 and is a value obtained by normalizing a distance in the x direction of each bright point of the quadrupole illumination from the optical axis by:

σ=(NAi)/(NAp) Equation 3

NAi is a numerical aperture made by the illumination light incident from the illumination optical system 215 of the exposure device 201 to the mask MK. NAp is a numerical aperture at a side of an image of the projection optical system 215 of the exposure device 201. In Equation 2, ay is specified by the σy information 44 and is a value obtained by normalizing the distance in the y direction of each bright point of the quadrupole illumination from the optical axis by σ in Equation 3. In Equations 1 and 2, λ is specified by the λ information 45 and is a wavelength λ of the exposure light of the exposure device 201 (see FIG. 4). In Equations 1 and 2, NA is specified by the NA information 46 and is a numerical aperture NA at a side of an image of the projection optical system 215 of the exposure device 201.

For example, a plurality of hole patterns HP1,1 to HP4,3 are arranged in the first block region BLR1 by repeatedly arranging the hole patterns with the pitch Px in the x direction and the pitch Py in the y direction, as illustrated in FIGS. 3B and 3C. Similarly, a plurality of hole patterns HP5,1 to HP8,3 are arranged in the second block region BLR2 by repeatedly arranging the hole patterns with the pitch Px in the x direction and the pitch Py in the y direction. The control unit 20, for example, overwrites and stores the pattern data 41 including information on the plurality of hole patterns HP1,1 to HP8,3, in the storage unit 40 as new pattern data 41, and generates the information on the plurality of hole patterns HP1,1 to HP8,3 as mask data 42 and stores the mask data 42 in the storage unit 40.

In step S2, the control unit 20 of the computer 1 specifies a pitch P across the inter-block regions IBR1 and IBR2 (see FIGS. 3B and 3C).

Specifically, an instruction to specify the pitch P across the inter-block regions IBR1 and IBR2 is input to the input unit 60 by the user. The control unit 20 receives the instruction to specify the pitch P and acquires the mask data 42 by referencing the storage unit 40 based on the instruction to specify the pitch P. The control unit 20 calculates the pitch P between the hole pattern (e.g., hole pattern HP4,3) in the first block region BLR1 closest to the second block region BLR2 and the hole pattern (e.g., hole pattern HP5,3) in the second block region BLR2 closest to the first block region BLR1 based on the mask data 42. For example, the control unit 20 extracts the inter-block regions IBR1 and IBR2 and sizes thereof from an entire surface of a chip based on the mask data 42 to thereby specify the inter-block regions IBR1 and IBR2 in which subsidiary patterns are to be arranged.

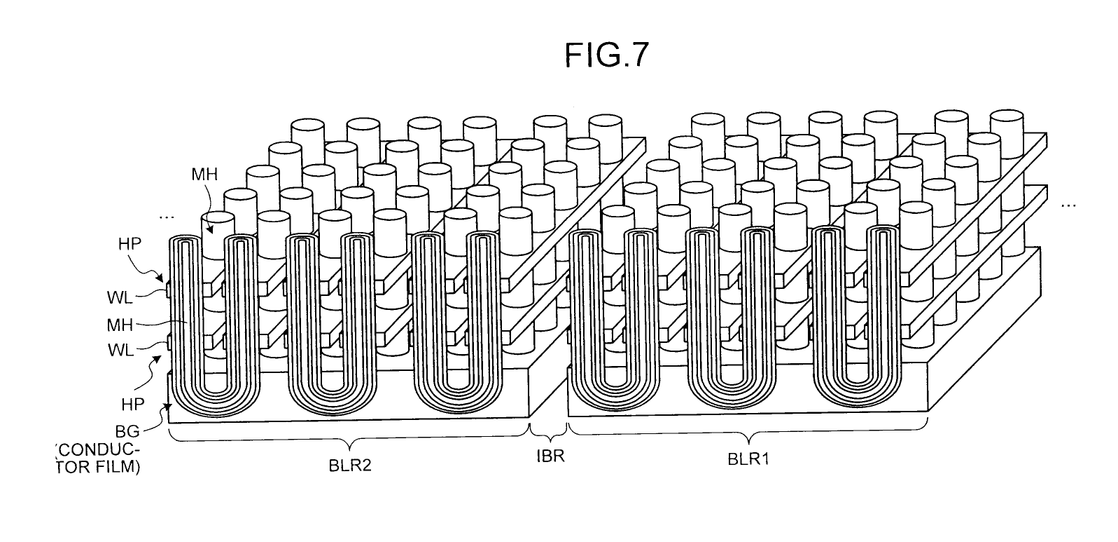

Further, the inter-block region IBR may be regarded, for example, as a region for locally perturbing periodicity of the arrangement of the hole patterns. Such an inter-block region IBR is provided, for example, to prevent unnecessary contact of patterns in a BiCS (Bit Cost Scalable) non-volatile semiconductor storage device as illustrated in FIG. 7. In the BiCS non-volatile semiconductor storage device, for example, an inter-block region IBR is provided between a block region BLR1 and a block region BLR2 in which a structure in which a U-shaped semiconductor member MH passes through a hole pattern HP of a plate-like word line WL is repeatedly provided. A width of the inter-block region IBR is, for example, ¼ Py to Py. In this case, the pitch P is, for example, 1.25 Py to 2 Py. If the pitch P is smaller than 1.25 Py, unnecessary contact of patterns is likely to occur. If the pitch P is greater than 2 Py, arrangement density of the hole patterns HP is degraded and arrangement density of the memory cells is also likely to be degraded.

In steps S3 to S5, the control unit 20 of the computer 1 judges an arrangement aspect of subsidiary patterns according to a relative size of the pitch P specified in step S2 to the pitch Py shown in Equation 2 and selects the arrangement aspect of subsidiary patterns. That is, the control unit 20 of the computer 1 determines a position in which the subsidiary pattern is to be arranged according to the relative size of the pitch P to the pitch Py, and the subsidiary pattern is arranged in the determined position.

Specifically, in step S3, the control unit 20 of the computer 1 judges whether the pitch P specified in step S2 is equal to or more than 1.5 times the pitch Py shown in Equation 2. If the pitch P is equal to or more than 1.5 times the pitch Py (“Yes” in step S3), the process of the control unit 20 proceeds to step S4. If the pitch P is less than 1.5 times the pitch Py (“No” in step S3), the process proceeds to step S5. For example, in the case illustrated in FIG. 3B, the pitch P is equal to or more than 1.5 times the pitch Py and the process proceeds to step S4, and in the case illustrated in FIG. 3C, the pitch P is less than 1.5 times the pitch Py and the process proceeds to step S5.

In step S4, the control unit 20 of the computer 1 arranges the subsidiary patterns in series in the inter-block region. For example, the control unit 20 arranges subsidiary patterns SRAF1,1 to SRAF1,3 on a plurality of first virtual lines VL1-1 to VL1-3 in the inter-block region IBR1, as illustrated in FIG. 3B. The plurality of first virtual lines VL1-1 to VL1-3 correspond to a plurality of columns of the hole patterns in the y direction in the first and second block regions BLR1 and BLR2. For example, the first virtual line VL1-1 corresponds to the column of hole patterns HP1,1 to HP8,1 in the y direction in the first and second block regions BLR1 and BLR2.

Further, an arrangement position in the y direction of, for example, the subsidiary pattern SRAF1,1 in the inter-block region IBR1 is not particularly limited as long as the arrangement position does not overlap the hole patterns HP4,1 and HP5,1 at both sides, but for example may be a midpoint position of a line segment that connects centers of the hole patterns HP4,1 and HP5,1 at both sides. Further, the case in which the arrangement number in the y direction of the subsidiary patterns in the inter-block region IBR1 is one has been illustrated in FIG. 3B, but the arrangement number in the y direction of the subsidiary patterns in the inter-block region IBR1 may be plural. In this case, the arrangement positions of a plurality of subsidiary patterns in the inter-block region IBR1 may be, for example, positions obtained by evenly dividing the line segment connecting the centers of the hole patterns HP4,1 and HP5,1 at both sides by “the number of subsidiary patterns to be arranged on the line segment”+1.

The control unit 20, for example, overwrites and stores the mask data 42 containing information on the plurality of subsidiary patterns SRAF1,1 to SRAF1,3 in the storage unit 40 as new mask data 42.

In step S5, the control unit 20 of the computer 1 arranges the subsidiary patterns in a staggered shape in the inter-block region. For example, the control unit 20 arranges subsidiary patterns SRAF1,12 and SRAF1,23 on a plurality of second virtual lines VL2-1 to VL2-2 in the inter-block region IBR2, as illustrated in FIG. 3C. The plurality of second virtual lines VL2-1 to VL2-2 are shifts of the first virtual lines VL1-1 and VL1-2 in the x direction by a pitch of 0.5 times the pitch Px shown in Equation 1. For example, the second virtual line VL2-1 is the shift of the first virtual line VL1-1 in a +x direction by the pitch of 0.5 times the pitch Px.

Further, an arrangement position in the y direction of, for example, the subsidiary pattern SRAF1,12 in the inter-block region IBR2 is not particularly limited as long as the arrangement position does not overlap hole patterns HP4,1, HP4,2, HP5,1 and HP5,2 at both sides, but for example may be a midpoint position of a line segment that connects centers of the hole patterns HP4,1 and HP5,2 at both sides. Further, the case in which the arrangement number in the y direction of the subsidiary patterns in the inter-block region IBR2 is one has been illustrated in FIG. 3C, but the arrangement number in the y direction of the subsidiary patterns in the inter-block region IBR2 may be plural. In this case, the arrangement positions of the plurality of subsidiary patterns in the inter-block region IBR2 may be, for example, positions obtained by evenly dividing the line segment connecting the centers of the hole patterns HP4,1 and HP5,2 at both sides by “the number of subsidiary patterns to be arranged on the line segment”+1.

The control unit 20, for example, overwrites and stores the mask data 42 containing information on the plurality of subsidiary patterns SRAF1,12 to SRAF1,23 in the storage unit 40 as new mask data 42.

In step S6, the control unit 20 of the computer 1 judges whether there is no problem such as proximity or overlapping between the main pattern and the subsidiary pattern. For example, when an interval between the main pattern and the subsidiary pattern is smaller than a given threshold (determined, for example, according to a design rule), the control unit 20 regards that there is a problem such as proximity or overlapping (“NG” in step S6) and the process proceeds to step S7. When the interval between the main pattern and the subsidiary pattern is equal to or more than the given threshold, the control unit 20 regards that there is no problem such as proximity or overlapping (“OK” in step S6) and the process proceeds to step S8.

Further, in step S6, the control unit 20 may further judge whether there is no problem such as proximity or overlapping between the subsidiary patterns. In this case, if there is at least one of the problem such as proximity or overlapping between the main pattern and the subsidiary pattern and the problem such as proximity or overlapping between the subsidiary patterns (“NG” in step S6), the process of the control unit 20 proceeds to step S7, and if there is no problem (“OK” in step S6), the process proceeds to step S8.

In step S7, the control unit 20 of the computer 1 performs adjustment of a size or a position of the subsidiary pattern. The control unit 20, for example, overwrites and stores the mask data 42 reflecting the adjustment result in the storage unit 40 as new mask data 42.

For example, the control unit 20 reduces the subsidiary pattern not to overlap the main pattern. Alternatively, for example, the control unit 20 may reduce the subsidiary pattern as well as the arrangement number not to overlap the main pattern.

In step S8, a drawing device (not illustrated) acquires the mask data 42 and draws a pattern such as Cr in the mask MK (see FIG. 4) according to the mask data 42.

Next, a configuration of the exposure device 201 for performing an exposure process using the generated mask MK will be described with reference to FIG. 4.

The exposure device 201 includes an exposure device main body 202 and a control device 205. The control device 205 includes an input unit 252, a main control unit 253, a storage unit 251, and a driving control unit 250. The main control unit 253 receives an exposure parameter (e.g., an exposure amount or a focus value) via the input unit 252, and stores the exposure parameter as exposure parameter information 254 in the storage unit 251. Further, the main control unit 253 controls each unit of the exposure device main body 202 via the driving control unit 250 based on the exposure parameter information 254.

The exposure device main body 202 includes a light source 210, an aperture stop 211, a filter 212, a polarization filter 213, an illumination optical system 214, and a projection optical system 215.

The aperture stop 211 is, for example, schematically disc-shaped, and includes a light emitting region (illumination region) and a non-light emitting region (illumination shielding region). The non-light emitting region is a region for shielding an exposure light 210a output from the light source 210, and the light emitting region is a region for transmitting the exposure light 210a output from the light source 210. That is, the aperture stop 211 makes an illumination shape as a quadrupole illumination (see FIG. 3A). In response thereto, illumination light of the quadrupole illumination is irradiated to the mask MK by the illumination optical system 214, and a latent image is formed in a photosensitive material (e.g., resist) 208 on a substrate 207 via the projection optical system 215. In this case, intensity distribution of an effective light source corresponding to the quadrupole illumination (see FIG. 3A) is formed in a pupil plane 2152 of the projection optical system 215.

The evaluation device 204 measures, for example, a finished dimension of the pattern formed on the substrate 207 and acquires the exposure parameter (e.g., exposure amount or focus value) used in the exposure process from the control device 205. The evaluation device 204 evaluates whether the finished dimension of the formed pattern satisfies a required specification for each exposure parameter (exposure amount or focus value).

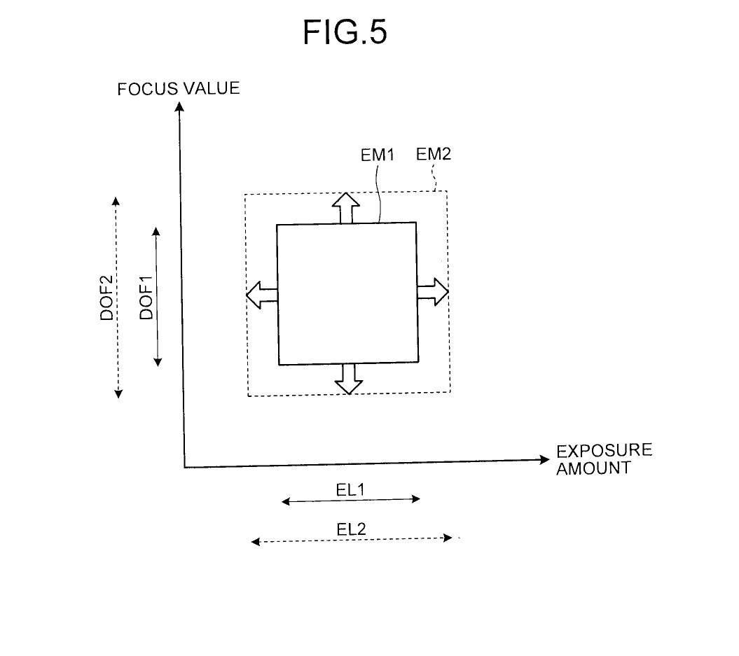

The evaluation device 204 plots the evaluation result on a scatter diagram in which the exposure amount is a horizontal axis and the focus value is a vertical axis, for example, as illustrated in FIG. 5, and obtains a size of an EM (exposure margin) including an EL (exposure latitude) and a DOF (depth of focus).

For example, the size of the exposure margin may be obtained as an area of a region satisfying a specification on the scatter diagram. For example, when the exposure latitude is EL1 and the depth of focus is DOF1, the size of the exposure margin EM1 is (EL1×DOF1). For example, when the exposure latitude is EL2 and the depth of focus is DOF2, the size of the exposure margin EM2 is (EL2×DOF2).

Alternatively, for example, the size of the exposure margin may be obtained as an average width in the vertical axis and the horizontal axis of the region satisfying the specification on the scatter diagram. For example, when the exposure latitude is EL1 and the depth of focus is DOF1, the size of the exposure margin EM1 is (EL1+DOF1)/2. For example, when the exposure latitude is EL2 and the depth of focus is DOF2, the size of the exposure margin EM2 is (EL2+DOF2)/2.

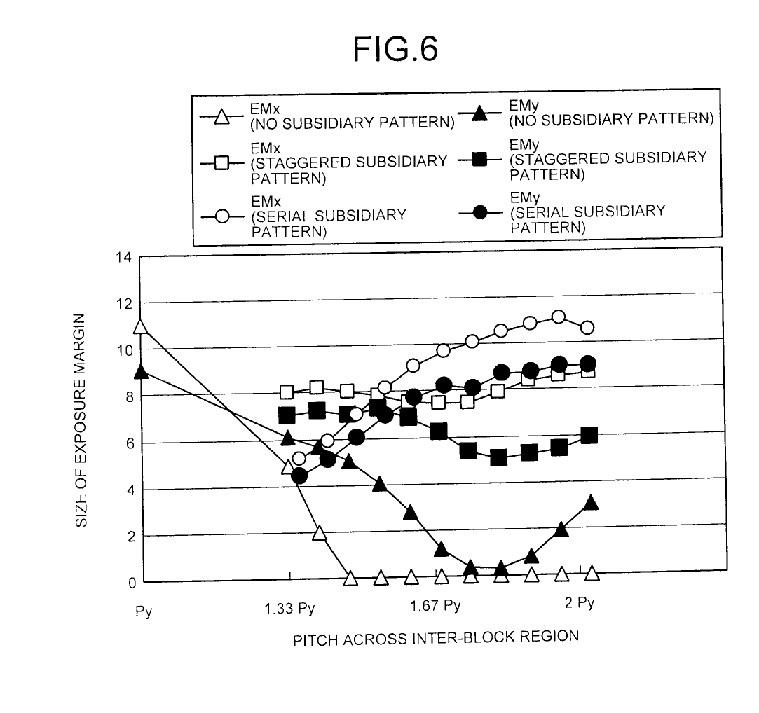

The evaluation result for a case in which there is no subsidiary pattern and a case in which there is a subsidiary pattern is illustrated in FIG. 6. In FIG. 6, the relative size of the pitch P across the inter-block region to the pitch Py is a horizontal axis, and the size of the exposure margin (in any unit) is a vertical axis. As the exposure margin is greater, the dimension of the pattern is robust against a change of the focus value or the exposure amount, and semiconductor fabrication is facilitated.

The change of the exposure margin is observed while decreasing the pitch P from 2 Py. The exposure margin in the x direction is 0 and then gradually increases from about 1.5 Py when there is no subsidiary pattern. The exposure margin is shown as about 11 in a portion of Py where there is no inter-block region.

Meanwhile, when there is a subsidiary pattern, the exposure margin when the size of the pitch P is from 2 Py to 1.33 Py, in which the exposure margin is low when there is no subsidiary pattern as illustrated in FIG. 6, can be enhanced. That is, it was confirmed, from any of serial subsidiary patterns corresponding to the subsidiary patterns SRAF1,1 to SRAF1,3 illustrated in FIG. 3B and staggered subsidiary patterns corresponding to the subsidiary patterns SRAF1,12 to SRAF1,23 illustrated in FIG. 3C, that the exposure margin can be enhanced in comparison with the case in which there is no subsidiary pattern.

It was also confirmed that the staggered subsidiary patterns are more effective at improving the exposure margin than the serial subsidiary patterns when the size of the pitch P is from 1.5 Py to 1.33 Py, and the serial subsidiary patterns are more effective at improving the exposure margin than the staggered subsidiary patterns when the size of the pitch P is equal to or more than 1.5 Py, as illustrated in FIG. 6.

A case in which subsidiary patterns are not arranged in the inter-block region between the first block region and the second block region is considered herein. In this case, the exposure margin of the hole patterns near the inter-block region in each of the first block region and the second block region tends to decrease. This tendency is not often stopped even when the width of the inter-block region increases such that the first block region is separated from the second block region. If the exposure margin of the hole pattern near the inter-block region decreases as described above, productivity of a semiconductor device fabricated through the exposure process is likely to be degraded.

On the other hand, in the embodiment, the subsidiary patterns are arranged in the inter-block region between the first block region and the second block region. Accordingly, the exposure margin can be improved in comparison with the case in which the subsidiary patterns are not arranged in the inter-block region (see FIG. 6). For example, the exposure margin EM2 can be more improved than the exposure margin EM1 when the subsidiary patterns are not arranged, as illustrated in FIG. 5.

Further, in the embodiment, an arrangement aspect of subsidiary patterns is changed according to a relative size of the pitch P between the hole patterns across the inter-block region in the y direction to the arrangement pitch Py in the y direction in each block region. That is, the position in which the subsidiary pattern is to be arranged is determined according to the relative size of the pitch P to the pitch Py, and the subsidiary pattern is arranged in the determined position. Accordingly, since the subsidiary pattern can be arranged in a position (arrangement aspect) suitable for the relative size of the pitch P to the pitch Py, the exposure margin can be efficiently improved.

Specifically, when the pitch P has a size of 1.5 times the pitch Py or more, the subsidiary patterns SPAF1,1 to SRAF1,3 are arranged in series, i.e., on the plurality of first virtual lines VL1-1 to VL1-3 in the inter-block region IBR1, respectively, for example as illustrated in FIG. 3B. When the pitch P has a size less than 1.5 times the pitch Py, the subsidiary patterns SRAF1,12 to SRAF1,23 are arranged in a staggered shape, i.e., on the plurality of second virtual lines VL2-1 to VL2-2 in the inter-block region IBR2, respectively, for example as illustrated in FIG. 3C. Accordingly, the exposure margin can be efficiently improved (see FIG. 6).

Further, in step S3 illustrated in FIG. 2, when the pitch P is equal to or more than 1.5 times the pitch Py and equal to or less than twice the pitch Py, the process of the control unit 20 of the computer 1 may proceed to step S4, when the pitch P is equal to or more than 1.25 times the pitch Py and less than 1.5 times the pitch Py, the process may proceed to step S5, and in other cases, the process may return to step S1. In this case, when the pitch P is more than twice the pitch Py, the process from the determination of the arrangement positions of the first and second block regions BLR1 and BLR2 in step S1 can be performed again instead of proceeding to step S4, thereby suppressing degradation of the arrangement density of the hole patterns. Further, when the pitch P becomes less than 1.25 times the pitch Py, the process from the determination of the arrangement positions of the first and second block regions BLR1 and BLR2 in step S1 can be performed again instead of proceeding to step S5, thereby suppressing unnecessary contact between patterns.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mask data generation method comprising:
repeatedly arranging hole patterns with a pitch Px in an x direction and a pitch Py in a y direction in each of a first block region and a second block region aligned in the y direction;
specifying a pitch P between the hole pattern in the first block region closest to the second block region and the hole pattern in the second block region closest to the first block region; and
determining a position in which a subsidiary pattern is to be arranged in an inter-block region between the first block region and the second block region according to a relative size of the pitch P to the pitch Py and arranging the subsidiary pattern in the determined position.

2. The mask data generation method according to claim 1, wherein
each of the hole patterns arranged in the first block region and the second block region has a dimension equal to or more than a resolution limit of an exposure device, and
each subsidiary pattern arranged in the inter-block region has a dimension less than the resolution limit of the exposure device.

3. The mask data generation method according to claim 1, wherein, in the arrangement of the subsidiary pattern,
when the pitch P has a size of 1.5 times the pitch Py or more, the subsidiary pattern is arranged on each of a plurality of first virtual lines in the inter-block region corresponding to a plurality of columns of the hole patterns in the y direction in the first block region and the second block region, and
when the pitch P has a size of less than 1.5 times the pitch Py, the subsidiary pattern is arranged on each of a plurality of second virtual lines in the inter-block region obtained by shifting the plurality of first virtual lines by a pitch of 0.5 times the pitch Px in the x direction.

4. The mask data generation method according to claim 3, wherein, in the arrangement of the subsidiary pattern,
the subsidiary pattern is arranged not to overlap any of the hole pattern in the first block region closest to the second block region and the hole pattern in the second block region closest to the first block region.

5. The mask data generation method according to claim 4, wherein, in the arrangement of the subsidiary pattern,
the subsidiary pattern is arranged in a midpoint position of a line segment connecting a center of the hole pattern in the first block region closest to the second block region with a center of the hole pattern in the second block region closest to the first block region on each of the plurality of first virtual lines or the plurality of second virtual lines.

6. The mask data generation method according to claim 4, wherein, in the arrangement of the subsidiary pattern,
the subsidiary pattern is temporarily arranged on each of the plurality of first virtual lines or the plurality of second virtual lines, and
when an interval between the temporarily arranged subsidiary pattern and the closest hole patterns in the first block region and the second block region is smaller than a threshold, the subsidiary pattern is reduced to have a size smaller than the temporarily arranged subsidiary pattern, and the reduced subsidiary pattern is arranged on each of the plurality of first virtual lines or the plurality of second virtual lines.

7. The mask data generation method according to claim 3, wherein, in the arrangement of the subsidiary pattern,
when the pitch P has a size of 1.5 times the pitch Py or more, plural subsidiary patterns are arranged on each of the plurality of first virtual lines not to overlap any of the hole pattern in the first block region closest to the second block region and the hole pattern in the second block region closest to the first block region.

8. The mask data generation method according to claim 7, wherein, in the arrangement of the plural subsidiary patterns,
the plural subsidiary patterns are arranged in positions obtained by dividing a line segment connecting a center of the hole pattern in the first block region closest to the second block region with a center of the hole pattern in the second block region closest to the first block region on each of the plurality of first virtual lines, by the number of the plural subsidiary patterns to be arranged on the line segment plus 1.

9. The mask data generation method according to claim 7, wherein, in the arrangement of the plural subsidiary patterns,
the plural subsidiary patterns are temporarily arranged on each of the plurality of first virtual lines, and
when at least one of an interval between the temporarily arranged plural subsidiary patterns and the closest hole patterns in the first block region and the second block region and an interval between the temporarily arranged plural subsidiary patterns themselves is smaller than a threshold, the plural subsidiary patterns are reduced to have a size smaller than the temporarily arranged plural subsidiary pattern, and the reduced plural subsidiary patterns are arranged on each of the plurality of first virtual lines.

10. The mask data generation method according to claim 7, wherein, in the arrangement of the plural subsidiary patterns,
the plural subsidiary patterns are temporarily arranged on each of the plurality of first virtual lines, and
when at least one of an interval between the temporarily arranged plural subsidiary patterns and the closest hole patterns in the first block region and the second block region and an interval between the temporarily arranged plural subsidiary patterns themselves is smaller than a threshold, the number of the plural subsidiary patterns decreases to be smaller than that of the temporarily arranged plural subsidiary patterns, and the decreased number of plural subsidiary patterns are arranged on each of the plurality of first virtual lines.

11. The mask data generation method according to claim 3, wherein, in the arrangement of the subsidiary pattern,
when the pitch P has a size of 1.5 times the pitch Py or more and 2.0 times the pitch Py or less, the subsidiary pattern is arranged on each of the plurality of first virtual lines, and when the pitch P has a size of 1.25 times the pitch Py or more and less than 1.5 times the pitch Py, the subsidiary pattern is arranged on each of the plurality of second virtual lines.

12. The mask data generation method according to claim 3, wherein
the mask data is data of a mask irradiated with illumination light of a quadrupole illumination by an illumination optical system and used to form a latent image in a photosensitive material via a projection optical system, and
in the arrangement of the hole patterns, when a ratio (NAi)/(NAp) of a numerical aperture NAi made by the illumination light incident from the illumination optical system to the mask and a numerical aperture NAp at a side of an image of the projection optical system is σ, values obtained by normalizing distances in the x and y directions of each bright point of the quadrupole illumination from an optical axis by σ are σx and σy, respectively, a numerical aperture at a side of the image of the projection optical system is NA, and a wavelength of exposure light is λ, the hole patterns are repeatedly arranged with a pitch:
Px=λ/(2×NA×σx)
in the x direction and a pitch:
Py=λ/(2×NA×σy)
in the y direction in each of the first block region and the second block region aligned in the y direction.

13. A mask generation method comprising:
generating data of a mask; and
generating a mask using the generated mask data,
wherein the generating data of a mask includes:
repeatedly arranging hole patterns with a pitch Px in an x direction and a pitch Py in a y direction in each of a first block region and a second block region aligned in the y direction;
specifying a pitch P between the hole pattern in the first block region closest to the second block region and the hole pattern in the second block region closest to the first block region; and
determining a position in which a subsidiary pattern is to be arranged according to a relative size of the pitch P to the pitch Py in an inter-block region between the first block region and the second block region, and arranging the subsidiary pattern in the determined position.

14. The mask generation method according to claim 13, wherein, in arrangement of the subsidiary pattern,
when the pitch P has a size of 1.5 times the pitch Py or more, the subsidiary pattern is arranged on each of a plurality of first virtual lines in the inter-block region corresponding to a plurality of columns of the hole patterns in the y direction in the first block region and the second block region, and when the pitch P has a size of less than 1.5 times the pitch Py, the subsidiary pattern is arranged on each of the plurality of second virtual lines in the inter-block region obtained by shifting the plurality of first virtual lines by a pitch of 0.5 times the pitch Px in the x direction.

15. The mask generation method according to claim 14, wherein, in the arrangement of the subsidiary pattern,
when the pitch P has a size of 1.5 times the pitch Py or more and 2.0 times the pitch Py or less, the subsidiary pattern is arranged on each of the plurality of first virtual lines, and when the pitch P has a size of 1.25 times the pitch Py or more and less than 1.5 times the pitch Py, the subsidiary pattern is arranged on each of the plurality of second virtual lines.

16. The mask generation method according to claim 14, wherein
the mask is to be irradiated with illumination light of a quadrupole illumination by an illumination optical system and used to form a latent image in a photosensitive material via a projection optical system, and
in the arrangement of the hole patterns, when a ratio (NAi)/(NAp) of a numerical aperture NAi made by the illumination light incident from the illumination optical system to the mask and a numerical aperture NAp at a side of an image of the projection optical system is σ, values obtained by normalizing distances in the x and y directions of each bright point of the quadrupole illumination from an optical axis by σ are σx and σy, respectively, a numerical aperture at a side of the image of the projection optical system is NA, and a wavelength of exposure light is λ, the hole patterns are repeatedly arranged with a pitch:
Px=λ/(2×NA×σx)
in the x direction and a pitch:
Py=λ/(2×NA×σy)
in the y direction in each of the first block region and the second block region aligned in the y direction.

17. A non-transitory computer-readable recording medium having a mask data generation program recorded thereon for causing a computer to generate data of a mask irradiated with illumination light by an illumination optical system and used to form a latent image in a photosensitive material via a projection optical system,
wherein the mask data generation program causes the computer to perform:
repeatedly arranging hole patterns with a pitch Px in an x direction and a pitch Py in a y direction in each of a first block region and a second block region aligned in the y direction;
specifying a pitch P between the hole pattern in the first block region closest to the second block region and the hole pattern in the second block region closest to the first block region; and
determining a position in which a subsidiary pattern is to be arranged in an inter-block region between the first block region and the second block region according to a relative size of the pitch P to the pitch Py and arranging the subsidiary pattern in the determined position.

18. The non-transitory computer-readable recording medium according to claim 17, wherein, in the arrangement of the subsidiary pattern,
when the pitch P has a size of 1.5 times the pitch Py or more, the subsidiary pattern is arranged on each of a plurality of first virtual lines in the inter-block region corresponding to a plurality of columns of the hole patterns in the y direction in the first block region and the second block region, and when the pitch P has a size of less than 1.5 times the pitch Py, the subsidiary pattern is arranged on each of the plurality of second virtual lines in the inter-block region obtained by shifting the plurality of first virtual lines by a pitch of 0.5 times the pitch Px in the x direction.

19. The non-transitory computer-readable recording medium according to claim 18, wherein, in the arrangement of the subsidiary pattern,
when the pitch P has a size of 1.5 times the pitch Py or more and 2.0 times the pitch Py or less, the subsidiary pattern is arranged on each of the plurality of first virtual lines, and when the pitch P has a size of 1.25 times the pitch Py or more and less than 1.5 times the pitch Py, the subsidiary pattern is arranged on each of the plurality of second virtual lines.

20. The non-transitory computer-readable recording medium according to claim 18, wherein
the mask is to be irradiated with illumination light of a quadrupole illumination by the illumination optical system,
in the arrangement of the hole patterns, when a ratio (NAi)/(NAp) of a numerical aperture NAi made by the illumination light incident from the illumination optical system to the mask and a numerical aperture NAp at a side of an image of the projection optical system is σ, values obtained by normalizing distances in the x and y directions of each bright point of the quadrupole illumination from an optical axis by σ are σx and σy, respectively, a numerical aperture at a side of the image of the projection optical system is NA, and a wavelength of exposure light is λ, the hole patterns are repeatedly arranged with a pitch:
Px=λ/(2×NA×σx)
in the x direction and a pitch:
Py=λ/(2×NA×σy)
in the y direction in each of the first block region and the second block region aligned in the y direction.
